(19) United States
(12) Patent Application Publication
(10) Pub. No.: US 2011/0268950 A1
(43) Pub. Date: Nov. 3, 2011

(54) Electromagnetic Wave Shielding Gel-Like Composition

(75) Inventors: Haruhiko Miyazawa, Tokyo (JP); Akihiko Mitsui, Tokyo (JP)

(73) Assignee: 3M INNOVATIVE PROPERTIES COMPANY, Saint Paul, MN (US)

(21) Appl. No.: 13/143,221

(22) PCT Filed: Jan. 6, 2010
(86) PCT No.: PCT/US2010/020184

§ 371 Date: Jul. 5, 2011

(30) Foreign Application Priority Data
Jan. 15, 2009 (JP) 2009-006994

(51) Int. Cl. H01F 1/12; H01F 1/147; B32B 27/00; C09K 5/00

(52) U.S. Cl. 428/220; 252/73; 252/62.51 R; 252/62.56; 252/62.55

(57) ABSTRACT

A gel-like composition that includes a gel, wherein the gel includes a polymer and an ionic liquid contained in the network of the polymer; and an electromagnetic wave suppressor, wherein the electromagnetic wave suppressor is dispersed in the gel and wherein the thermal conductivity of the gel-like composition is at least 0.8 W/mK.

### FIELD

Disclosed herein are gel-like compositions. More specifically, gel-like compositions containing an ionic liquid and an electromagnetic wave suppressor are disclosed.

### BACKGROUND

In recent years, there have been significant advances in the performance of various electronic devices such as wireless devices and digital cameras due, at least in part, to realization of new high-density and high-performance semiconductor devices. These advanced electronic devices tend to generate high-frequency waves. Because of this, methods are needed for blocking the outside release of the electromagnetic waves emanating from such electronic devices and for blocking the effect of external electromagnetic waves on the electronic devices.

Ionic liquids (also called ambient temperature molten salts) are materials that have recently received attention in electrolytic solutions and the like. These materials can have high conductivity while being a nonvolatile liquid at ambient temperature.

Kokai (Japanese Unexamined Patent Publication) No. 2006-128570 and Kokai No. 2007-27470 disclose electromagnetic wave suppressing members that utilize ionic liquids. Kokai No. 2006-128570 describes “an electromagnetic wave shielding material which is a member comprising rubber or elastomer and has electromagnetic shielding property.” The electromagnetic wave shielding material is “a polymer elastic body containing an ionic liquid and at least either one of an electrically conductive particle and an electrically conductive fiber” and “a part of an electrically conductive carbon, metal fiber or carbon fiber as an electrically conductive filler is replaced by an ionic liquid”. Kokai No. 2007-27470 describes an electromagnetic wave suppressing member that includes a gel-like material containing substantially only an ionic liquid. U.S. Patent Application Publication No. 2004/0149472 describes an electromagnetic wave absorber prepared by sealing an ionic liquid between a pair of windowpanes, and WO2006/053083 describes an electromagnetic wave suppressing member obtained by polymerizing a monomer constituting an ionic liquid.

### SUMMARY

Disclosed herein is a gel-like composition that includes a gel and an electromagnetic wave suppressor. The gel includes a polymer and an ionic liquid contained in a network of the polymer. The electromagnetic wave suppressor is dispersed in the gel. The thermal conductivity of the gel-like composition is at least 0.8 W/mK.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

FIG. 1 is a graph illustrating the electromagnetic wave absorbing performance of Example 1 and Comparative Examples 4 and 5.

FIG. 2 is a graph illustrating the electromagnetic wave absorbing performance of Example 3 and Comparative Examples 1 to 3.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

Most electronic devices include integrated circuit boards that can generate heat. Although heat sinks are often provided, improved thermally conductive members for efficiently transferring heat to the heat sink from the integrated circuit would be beneficial. Additionally, many electronic devices emit high frequency waves or need shielding from external high frequency waves. Improved electromagnetic wave suppressing materials would be beneficial. Because space is generally limited in small electronic devices so, it would be advantageous to have a single component with both electromagnetic wave suppressing properties and thermally conductive properties. It would be even further advantageous if such a component was also easily formable and flexible to conform to the space within the electronic device.

There are currently known dual function materials that are obtained by dispersing an electromagnetic wave absorber, such as a magnetic material, and a thermally conductive particle in a silicone resin or a silicone gel. However, the silicone resin itself is expansive and in addition, the silicone resin is suspected to generate a low molecular-weight siloxane gas that can cause operational failures of hard disks or fogging of camera lenses. Because of these drawbacks, materials without silicone are thought to be advantageous.

Therefore, there remains a need for materials that have electromagnetic wave suppressing properties and thermally conductive properties that do not suffer the disadvantages brought about by the use of silicone.

Disclosed herein is a gel-like composition that does not contain silicone. The gel-like composition includes a gel having an electromagnetic wave suppressor dispersed therein. The gel includes a polymer and an ionic liquid contained in a network of the polymer. Therefore, the gel-like composition has both electromagnetic wave suppressing properties and thermal conductive properties. In embodiments, the compositions can have thermal conductivities of at least 0.8 W/mK or more.

The disclosed gel-like compositions can have a synergistic electromagnetic wave suppressing ability based on the dielectric properties of the ionic liquid and the electromagnetic wave suppressor. The gel-like composition can also be thermally conductive because of the interaction between the ionic liquid and the electromagnetic wave suppressor dispersed therein. The use of an ionic liquid instead of materials containing silicone can minimize concerns about volatile gases such as siloxane gas. Because the ionic liquid is contained in the network of the polymer, the polymer is typically flexible and can be easily processed.

The term “gel” as used herein refers to a dispersion-type solution that has a relatively high viscosity and that is unable to flow. The term “ionic liquid” as used herein refers to a substance that is an electrolyte having an anion and a cation and that is present in a liquid state under normal temperature and pressure (25° C., 1 atm (1×10⁵ Pa)). An “ionic liquid” can also be referred to as an “ambient temperature molten salt”. The term “electromagnetic suppressor” as used herein refers to a material that is capable of reflecting or absorbing an electromagnetic wave.

The phrases “an electromagnetic wave suppressor dispersed in a gel” and “an electromagnetic wave suppressor dispersed in an ionic liquid” can refer to the same thing and can indicate that an electromagnetic waver suppressor is dispersed in an ionic liquid and the overall composition constitutes a gel.

Gel-like compositions as disclosed herein can take any shape. In embodiments, the gel-like compositions can be formed into a sheet and can be used to coat electronic circuits or the like, which could benefit from electromagnetic wave suppression and/or heat dissipation, directly or through an insulating layer.

Gel-like compositions disclosed herein include an electromagnetic wave suppressor. Gel-like compositions can include one or more than one kind of electromagnetic wave suppressor material. Electromagnetic wave suppressors can include materials having electromagnetic wave absorbing effects, materials that have electromagnetic wave reflecting effects, or both. Exemplary materials include electric conductors, carbon materials, dielectric materials and magnetic materials. Examples of electric conductors include Al, Fe, Ni, Cr, Cu, Au, Ag and alloys thereof. Examples of carbon materials include carbon black, carbon fibers, carbon nanotubes, fullerene and diamond. Examples of dielectric materials include SiO₂, Al₂O₃, barium titanate and titanium oxide. Examples of magnetic materials include alloys or oxides containing transition elements such as ferrite, permalloy (Fe—Ni-based alloy) and sendust (Al—Si—Fe-based alloy).

In embodiments, sendust, ferrite and the like can be utilized. Such materials are soft magnetic materials with high electromagnetic absorptivity. Specific examples of soft magnetic ferrites include manganese zinc ferrite, nickel zinc ferrite and copper zinc ferrite.

The ionic liquid can also (along with the electromagnetic wave suppressor) have the effect of suppressing electromagnetic waves. The overall electromagnetic wave suppressing function can be effective over a wide range including from 100 MHz to 3 GHz. In embodiments where a soft magnetic material such as sendust or ferrite is used as the electromagnetic wave suppressor, the power loss indicative of the electromagnetic wave absorbing performance at 1 GHz can be 3% or more, or even 15% or more. Such power losses can be seen in sheets of gel-like compositions having thicknesses from 0.3 to 5.0 mm.

The electromagnetic wave suppressor can be utilized as fine particles in a spherical form, or other forms such as rods, plates, fibers or flat forms. In embodiments flat or needle-like fine particles having large specific surface areas can be utilized. Such electromagnetic wave suppressors can enhance the electromagnetic wave suppressing ability of the gel-like composition.

The particle size of the electromagnetic wave suppressor is not particularly limited. In embodiments where the gel-like composition is to be used in a sheet, the size of the particles can be small relative to the thickness of the sheet in order to maintain the flexibility of the sheet. In embodiments, the diameter of the particles can be ⅕ or less, or 1/10 or less, of the thickness of the sheet, for example. In embodiments, the particles can be from 0.1 to 500 μm, or from 1 to 200 μm for example.

The diameter of particles can be measured using a scanning electron microscope (SEM), a transmission electron microscope (TEM), a laser diffraction scattering particle diameter distribution measuring apparatus, a dynamic light scattering photometer (DLS) or the like. The point at which the diameter of the particle can be measured can vary depending on the shape of the particle. For a spherical or nearly spherical particle, the diameter of the particle can equal the maximum diameter at a cross-section passing through the center of gravity. For a rod shaped particle, the diameter at the bottom, or the height of the rod, whichever is longer, can be given as the diameter of the particle. For a flat particle, the diameter of the particle can equal the maximum diameter of the plate surface. For a fiber-shaped particle, the diameter of the particle can equal the fiber length.

An appropriate flat particle can also be described by the aspect ratio and the thickness. For example, a flat particle having an average particle thickness of 0.5 to 3 micrometers (μm) and an aspect ratio (particle diameter/particle thickness) of from 2 to 100 or from 10 to 60 can be utilized in gel-like compositions herein. In embodiments, particles having average thicknesses of about 0.5 μm or less can have decreased magnetic permeability due to the effect of working. As used herein, the term “working refers to a process of pressing particles to make them more flat. During such processes, the crystal structure can be broken resulting in decreased magnetic permeability. In embodiments, particles having average particle thicknesses that exceed 3 μm are likely to have reduced magnetic permeability due to eddy currents.

When electromagnetic wave suppressors are mixed with an ionic liquid, ionic charges tend to surround the periphery of the particles and therefore individual particles tend to be surrounded by an electric charge. Because of that, the particles tend to repel each other, thereby suppressing aggregation and maintaining the particles dispersed in the solution. This can allow the electromagnetic wave suppressor to be successfully dispersed in a relatively large amount of an ionic liquid without adding a dispersion aid or the like.

The electromagnetic wave suppressing ability can depend on the kind, shape, size and content of the electromagnetic wave suppressor contained in the gel-like composition. In general, as the content of the electromagnetic wave suppressor increases, the electromagnetic wave suppressing effect becomes higher. In embodiments therefore, higher electromagnetic wave suppressing properties can be obtained by increasing the amount of a particulate electromagnetic wave suppressor in the gel-like composition to 20 mass % or more, to 30 mass % or more, or to 60 mass % or more. In embodiments that utilize flat sendust particles or the like, the electromagnetic wave absorbing properties are more effectively displayed and therefore acceptable electromagnetic wave absorbing properties can be obtained with an amount of 10 mass % or more, 15 mass % or more, or 20 mass % or more.

In embodiments where the amount of the electromagnetic wave suppressor in the ionic liquid exceeds a given amount, a greater than expected increase in magnetic wave suppression may be produced. The reason for the greater than expected increase is not known, but it is thought to be a synergistic effect brought about by the combination of an ionic liquid and an electromagnetic wave suppressor.

The greater than expected increase in electromagnetic wave suppression can often be seen when using a ferrite as the electromagnetic wave suppressor. For example, when manganese zinc ferrite is utilized, an abrupt increase in the electromagnetic wave suppressing effect can be observed when the content exceeds about 60 mass % or about 70 mass %. The same unexpected increase, when using manganese zinc ferrite, can be seen when the content exceeds about 30 vol % or more, about 40 vol % or more, or about 45 vol % or more. In such embodiments, the ferrite particles can be nearly spherical and can have average particle diameter of from 1 to 50 μm or from 1 to 10 μm.

In embodiments utilizing flat sendust particles, the unexpected increase can be seen when the particles have an aspect ratio of 10 to 50 and an average particle diameter of about 100 μm or less (or in embodiments from 30 to 50 μm), and are present in the gel-like composition at about 7 vol % or more (or in embodiments about 8 vol % or more, or 10 vol % or more) or 30 mass % or more (or in embodiments 40 mass % or more).

Gel-like compositions disclosed herein can also have high thermal conductivities due to the dispersion of the electromagnetic wave suppressor in the ionic liquid. In embodiments, disclosed gel-like compositions can have thermal conductivities of 0.8 W/mK or more. In embodiments, gel-like compositions can have thermal conductivities of 1.0 W/mK or more or even 1.2 W/mK or more.

Although the basis for the relatively high thermal conductivities is not clear, it may be due to the wave shielding or absorbing effect of the electromagnetic wave suppressor. The shielding or absorbing effect may have an electrical polarity that can create an electrical balance in the peripheral ionic liquid. This electrical balance may produce an oriented state in the ionic liquid, which causes a kind of crosslinked state between dispersed electromagnetic wave suppressors. The pseudo-crosslinking can provide a thermal conduction route for effectively transferring heat, thereby increasing the thermal conductive property of the material. This effect can be increased when the content of the electromagnetic wave suppressor dispersed in the gel exceeds a given amount and the electromagnetic wave suppressors are in close proximity to each other.

The increase in thermal conductivity of disclosed gel-like compositions can vary depending on the kind, content, particle shape, particle size or the like of the ionic liquid or electromagnetic wave suppressor utilized. In embodiments, where a soft magnetic material, such as a ferrite (for example, manganese zinc ferrite, nickel zinc ferrite or copper zinc ferrite) are 30 vol % or more (for example, 40 vol % or more and 45 vol % or more) thermal conductivities of 0.8 W/mK or more can be obtained. In such embodiments where the content of the soft magnetic material is 50 vol % or more, a thermal conductivity of 1.2 W/mK or more can be obtained. In embodiments where the content of the soft magnetic ferrite is 70 mass % or more, thermal conductivities of 0.8 W/mK or more can be obtained. In embodiments where the content of the soft magnetic material is 80 mass % or more, thermal conductivities of 1.2 W/mK or more can be obtained. In such embodiments, the ferrite particles can be nearly spherical particles having an average particle diameter of from 1 to 50 μm or from 1 to 10 μm.

In embodiments where sendust fine particles are contained in an amount of 7 vol % or more in the gel-like composition, thermal conductivities of 0.8 W/mK or more can be obtained. In embodiments where sendust particles are contained in an amount of 25 mass % or more, thermal conductivities of 0.8 W/mK or more can be obtained. Even higher thermal conductivities can be obtained in embodiments where the sendust content is 8 vol % or more (or 10 vol % or more) or 30 mass % or more (or 40 mass % or more). In embodiments where flat particles having an aspect ratio of 10 to 50 are utilized, high thermal conductivities can be exhibited with smaller amounts of particles. For example, flat particles having an average particle diameter of from 1 to 100 μm (or from 10 to 50 μm) can be utilized.

Gel-like compositions disclosed herein also include an ionic liquid. One or more than one kind of ionic liquid may be utilized in a gel-like composition. Disclosed gel-like compositions maintain a gel state and maintain flexibility by containing an ionic liquid in the network of the polymer. Because the ionic liquid does not leak from the gel-like composition, handling of the composition is facilitated. Unlike commercially available gels containing silicone, the ionic liquid is nonvolatile and therefore gas is not generated.

Ionic liquids that can be utilized are not particularly limited and any suitable commonly utilized ionic liquids can be used. Ionic liquids that can be utilized are generally liquid at normal temperatures, are nonvolatile and have dielectric properties. It is because of the dielectric property of the ionic liquid that it can also absorb electromagnetic waves.

The cation, anion, or the combination thereof in the ionic liquid is generally not limited. Exemplary cations include primary (RiNH₃⁺), secondary (RiR₂NH₂⁺), tertiary (RiR₂R₃NH⁺), quaternary (RiR₂R₃R₄N⁺) chain ammonium cations (in the previous formulas, R₁, R₂, R₃ and R₄ are each independently a linear or branched C₁ to C₁₅ alkyl group, a linear or branched C₁ to C₁₅ alkyl group having one or more hydroxyl groups on a side chain, or a phenyl group) or a cyclic ammonium cation. Examples of cyclic ammonium cations include oxazolium, thiazolium, imidazolium, pyrazolium, pyrrolinium, furazanium, triazolium, pyrrolidinium, imidazolidinium, pyrazolidinium, pyrrolinium, imidazolinium, pyrazolinium, pyrazinium, pyrimidinium, pyridazinium, piperidinium, piperazinium, morpholinium, indolium and carbazolium. Further exemplary cations include chain phosphonium cations (R₅R₆R₇P⁺ and R₅R₆R₇R₈P⁺), chain sulfonium cations (R₉R₁₀R₁₁S⁺) (in the previous formulas, R₅, R₆, R₇, R₈, R₉, R₁₀ and R₁₁ are each independently a linear or branched C₁ to C₁₂ alkyl group or a phenyl group), and cyclic sulfonium cations. Examples of cyclic sulfonium cations include thiophenium, thiazolinium and thiopyranium.

In embodiments where quaternary ammonium cations are utilized as the cation, high-temperature heat resistance of 120° C. or more can be imparted to the gel-like composition. This can be advantageous in maintaining a stable performance in applications having increased temperatures due to heat generation from electronic devices or semiconductor devices where the composition is utilized. Such compositions could also be utilized in electronic devices or the like in vehicles where high-temperature heat resistance is advantageous.

Exemplary anions include inorganic acid-based ions such as phosphates, sulfates and carboxylates as well as fluorine-based anions or the like. Examples of fluorine-based anions include tetrafluoroborate (BF₄⁻), hexafluorophosphate (PF₆⁻), hexafluoroarcenate (AsF₆⁻), trifluoromethylsulfonate (CF₃SO₃⁻), bis(fluorosulfonyl)imide [(FSO₂)₂N⁻], bis(trifluoromethylsulfonyl)imide [(CF₃SO₂)₂N⁻], bis(trifluoroethylsulfonyl)imide [(CF₃CF₂SO₂)₂N⁻], and tris(trifluoromethylsulfonylmethide) [(CF₃SO₂)₃C⁻].

In embodiments non-halogen-based anions can be utilized as the anion in the ionic liquid. In embodiments utilizing phosphate-based anions profitability can be increased because of the relatively low cost as compared with fluorine-based anions. The phosphate-based anions can additionally offer the added benefit of high flame retardance. Exemplary phosphate-based anions include phosphoric acid group-containing salts such as [PO₄³⁻], [RPO₄²⁻] and [RR′PO₄⁻] (wherein R and R′ each independently represent hydrogen, a linear or branched C₁ to C₈ alkyl group, or a phenyl group). Specific examples thereof include a phosphoric acid (PO₄³⁻, HPO₄²⁻, H₂PO₄⁻), a phosphoric acid monoester (RPO₄²⁻, HRPO₄⁻), and a phosphoric acid diester (R₂PO₄⁻) (wherein R is a linear or branched C₁ to C₈ alkyl group).

The amount of the ionic liquid in the gel-like composition is not particularly limited. When the ionic liquid is present in an amount of 10 mass % or more in the gel-like composition, the gel-like composition is generally flexible. When the ionic liquid is present in an amount of 14 mass % or more (or 20 mass % or more, or 40 mass % or more, or 50 mass % or more, or 56 mass % or more) even higher flexibility can be obtained and the electromagnetic wave absorbing effect of the ionic liquid can also enhance the electromagnetic wave suppressing effect of the overall gel-like composition. In embodiments where the gel-like composition contains only a polymer, an ionic liquid, and an electromagnetic wave suppressor, and the ionic liquid is present in an amount of 50 mass % or more (or in embodiments 70 mass % or more) the gel-like composition can be very flexible. Because of the increased flexibility, the gel-like composition can have relatively good adherence when coated onto an article, such as an electrical component. This can also contribute to an increased efficiency of heat dissipation.

In embodiments, ionic liquid can be present as necessary to maintain the gel structure of the gel-like composition. In embodiments, the ionic liquid is present in an amount of 90 mass % or less, or in embodiments 80 mass % or less, based on the entire gel-like composition. In general, the amount of ionic liquid can be chosen based on the amount of electromagnetic wave suppression and thermal conductivity desired.

The ionic liquid can cause friction in the bond portion due to the presence of, for example, an ion bond between cation and anion and a hydrogen bond between polymer structure and ionic liquid and therefore, can exert a higher impact absorbing ability by converting an impact energy into a heat energy through vibration and friction. That is, these ionic bonds tend to suppress movement and the impact energy (kinetic energy) is converted into heat energy. As the amount of the ionic liquid in the gel-like composition increases, the impact absorbing property can increase. Therefore, for gel-like compositions that have impact absorbing properties, the content of the ionic liquid may be increased as long as the gel structure can be maintained.

Gel-like compositions disclosed herein also include a polymer. The polymer can be added to the composition as a polymer or as a monomer and then polymerized. In embodiments one or more than one kind of monomer or polymer may be utilized in a gel-like composition. Any commonly utilized polymers can be used herein, as long as it can form a gel state. The network of the polymer functions to maintain a gel state despite changes in temperature, prevents the ionic liquid from leaking from the gel-like composition, and imparts flexibility and ease of processing to the gel-like composition. The polymer network can be produced by copolymerizing a monomer or a polymer utilizing a crosslinking agent.

In embodiments utilizing polymers containing at least an acidic group or a basic group polymerizing the network in the presence of the ionic liquid can take advantage of hydrogen bonds (between the polymer and the ionic liquid) to maintain the ionic liquid in the network of the polymer. That is, the monomers, polymers, or both can have ionic groups. These ionic groups can easily result in the formation of a stable gel state. This can also be a reason to increase the amount of ionic liquid in the gel-like composition.

Examples of acidic groups include carboxyl groups, hydroxyl groups and sulfonic acid groups. Examples of basic groups include primary, secondary or tertiary amine groups, primary, secondary, or tertiary ammonium groups, amide groups, imidazole groups, imide groups, morpholine groups and piperidyl groups.

Polymers that can be utilized in gel-like compositions include homopolymers, copolymers or terpolymers. The polymers can be formed from monomers having at least one member selected from vinyl-based derivatives having the above-described acidic or basic groups or salts thereof, polysaccharides such as cellulose, starch and hyaluronic acid, phenolic resins and epoxy resins.

Specific examples of monomers having a carboxyl group as the acidic group include acrylic acid, ammonium acrylate, sodium acrylate, lithium acrylate, methacrylic acid, ammonium methacrylate, sodium methacrylate, lithium methacrylate, 2-acryloyloxyethyl phthalate, 2-methacryloyloxyethyl phthalate, 2-acryloyloxyethyl hexahydrophthalate, 2-methacryloyloxyethyl hexahydrophthalate, 2-acryloyloxypropyl acrylate, 2-methacryloyloxypropyl acrylate, ethylene oxide-modified acrylate succinate, ethylene oxide-modified methacrylate succinate, propylene oxide-modified acrylate succinate and propylene oxide-modified methacrylate succinate.

In embodiments where polyacrylic acid is utilized as the polymer, good compatibility with the ionic liquid can be obtained which even further limits the possibility of bleed-out. Furthermore, hydrogen bonding between the polymer and the ionic liquid allows the polymer matrix to contain an even larger amount of ionic liquid. Therefore, embodiments such as this can provide a gel-like composition that includes a relatively high content of ionic liquid.

Embodiments that include acrylic resins such as acrylic acid homopolymers or copolymers as the polymer can also provide, self-adhesive properties to the gel-like composition. Such compositions could be laminated directly to a surface without the need for a pressure-sensitive adhesive layer.

Examples of monomers having hydroxyl groups as acidic groups include 2-hydroxyethyl acrylate, 2-hydroxyethyl methacrylate, 2-hydroxypropyl acrylate, 2-hydroxypropyl methacrylate, 4-hydroxybutyl acrylate, 4-hydroxybutyl methacrylate, 2-hydroxybutyl acrylate, 2-hydroxybutyl methacrylate, epichlorohydrin (ECH)-modified phenoxy acrylate, ECH-modified phenoxy methacrylate, glycerol acrylate, glycerol methacrylate, ethylene glycol acrylate, ethylene glycol methacrylate, polyethylene glycol acrylate, polyethylene glycol methacrylate, propylene glycol acrylate, propylene glycol methacrylate, polypropylene glycol acrylate, polypropylene glycol methacrylate, 2-hydroxyethylacrylamide, 2-hydroxypropylacrylamide, 2-hydroxybutylacrylamide, vinyl alcohol and acrylonitrile.

Examples of monomers having sulfonic acid groups as acidic groups include 2-acryloyloxyethylsulfonic acid, 2-methacryloxyethylsulfonic acid, sodium 2-acryloyloxyethylsulfonate, lithium 2-acryloyloxyethylsulfonate, ammonium 2-acryloyloxyethylsulfonate, imidazolium 2-acryloyloxyethylsulfonate, pyridinium 2-acryloyloxyethylsulfonate, sodium 2-methacryloxyethylsulfonate, lithium 2-methacryloxyethylsulfonate, ammonium 2-methacryloxyethylsulfonate, imidazolium 2-methacryloxyethylsulfonate, pyridinium 2-methacryloxyethylsulfonate, styrenesulfonic acid, sodium styrenesulfonate, lithium styrenesulfonate, ammonium styrenesulfonate, imidazolium styrenesulfonate and pyridinium styrenesulfonate.

In embodiments where an easily oxidizable metallic magnetic material is utilized as the electromagnetic wave suppressor, monomers having an acidic group can be utilized to suppress the oxidation of the metallic magnetic material. In embodiments, weakly acidic hydroxyl or carboxyl groups can be utilized as the acidic group.

Examples of monomers having primary, secondary or tertiary amine groups as basic groups include dimethylaminoethyl acrylate, dimethylaminopropyl acrylate, dimethylaminobutyl acrylate, dimethylaminoethyl methacrylate, dimethylaminopropyl methacrylate, dimethylaminobutyl methacrylate, 2-hydroxy-3-dimethylaminopropyl acrylate, 2-hydroxy-3-dimethylaminopropyl methacrylate, diethylaminoethyl acrylate, diethylaminopropyl acrylate, diethylaminobutyl acrylate, diethylaminoethyl methacrylate, diethylaminopropyl methacrylate, diethylaminobutyl methacrylate, 2-hydroxy-3-diethylaminopropyl acrylate, 2-hydroxy-3-diethylaminopropyl methacrylate, dimethylaminoethylacrylamide, dimethylaminopropylacrylamide, dimethylaminobutylacrylamide, diethylaminoethylacrylamide, diethylaminopropylacrylamide and diethylaminobutylacrylamide.

Still other examples of monomers having primary, secondary, tertiary or quaternary ammonium groups as basic groups include acryloyloxyethyl dimethylammonium fluoride, acryloyloxyethyl dimethylammonium chloride, acryloyloxyethyl dimethylammonium bromide, acryloyloxyethyl dimethylammonium iodide, acryloyloxypropyl dimethylammonium fluoride, acryloyloxypropyl dimethylammonium chloride, acryloyloxypropyl dimethylammonium bromide, acryloyloxypropyl dimethylammonium iodide, acryloyloxybutyl dimethylammonium chloride, acryloyloxybutyl dimethylammonium bromide, acryloyloxybutyl dimethylammonium iodide, methacryloxyethyl dimethylammonium fluoride, methacryloxyethyl dimethylammonium chloride, methacryloxyethyl dimethylammonium bromide, methacryloxyethyl dimethylammonium iodide, methacryloxypropyl dimethylammonium fluoride, methacryloxypropyl dimethylammonium chloride, methacryloxypropyl dimethylammonium bromide, methacryloxypropyl dimethylammonium iodide, methacryloxybutyl dimethylammonium fluoride, methacryloxybutyl dimethylammonium chloride, methacryloxybutyl dimethylammonium bromide, methacryloxybutyl dimethylammonium iodide, acryloyloxyethyl trimethylammonium fluoride, acryloyloxyethyl trimethylammonium chloride, acryloyloxyethyl trimethylammonium bromide, acryloyloxyethyl trimethylammonium iodide, acryloyloxypropyl trimethylammonium fluoride, acryloyloxypropyl trimethylammonium chloride, acryloyloxypropyl trimethylammonium bromide, acryloyloxypropyl trimethylammonium iodide, acryloyloxybutyl trimethylammonium fluoride, acryloyloxybutyl trimethylammonium chloride, acryloyloxybutyl trimethylammonium bromide, acryloyloxybutyl trimethylammonium iodide, methacryloxyethyl trimethylammonium fluoride, methacryloxyethyl trimethylammonium chloride, methacryloxyethyl trimethylammonium bromide, methacryloxyethyl trimethylammonium iodide, methacryloxypropyl trimethylammonium fluoride, methacryloxypropyl trimethylammonium chloride, methacryloxypropyl trimethylammonium bromide, methacryloxypropyl trimethylammonium iodide, methacryloxybutyl trimethylammonium fluoride, methacryloxybutyl trimethylammonium chloride, methacryloxybutyl trimethylammonium bromide, methacryloxybutyl trimethylammonium iodide, 2-hydroxy-3-acryloyloxypropyl dimethylammonium fluoride, 2-hydroxy-3-acryloyloxypropyl dimethylammonium chloride, 2-hydroxy-3-acryloyloxypropyl dimethylammonium bromide, 2-hydroxy-3-acryloyloxypropyl dimethylammonium iodide, 2-hydroxy-3-acryloyloxypropyl diethylammonium fluoride, 2-hydroxy-3-acryloyloxypropyl diethylammonium chloride, 2-hydroxy-3-acryloyloxypropyl diethylammonium bromide, 2-hydroxy-3-acryloyloxypropyl diethylammonium iodide, 2-hydroxy-3-acryloyloxypropyl trimethylammonium fluoride, 2-hydroxy-3-acryloyloxypropyl trimethylammonium chloride, 2-hydroxy-3-acryloyloxypropyl trimethylammonium bromide, 2-hydroxy-3-acryloyloxypropyl trimethylammonium iodide, 2-hydroxy-3-acryloyloxypropyl triethylammonium fluoride, 2-hydroxy-3-acryloyloxypropyl triethylammonium chloride, 2-hydroxy-3-acryloyloxypropyl triethylammonium bromide, 2-hydroxy-3-acryloyloxypropyl triethylammonium iodide, 2-hydroxy-3-methacryloxypropyl dimethylammonium fluoride, 2-hydroxy-3-methacryloxypropyl dimethylammonium chloride, 2-hydroxy-3-methacryloxypropyl dimethylammonium bromide, 2-hydroxy-3-methacryloxypropyl dimethylammonium iodide, 2-hydroxy-3-methacryloxypropyl diethylammonium fluoride, 2-hydroxy-3-methacryloxypropyl diethylammonium chloride, 2-hydroxy-3-methacryloxypropyl diethylammonium bromide, 2-hydroxy-3-methacryloxypropyl diethylammonium iodide, 2-hydroxy-3-methacryloxypropyl trimethylammonium fluoride, 2-hydroxy-3-methacryloxypropyl trimethylammonium chloride, 2-hydroxy-3-methacryloxypropyl trimethylammonium bromide, 2-hydroxy-3-methacryloxypropyl trimethylammonium iodide, 2-hydroxy-3-methacryloxypropyl triethylammonium fluoride, 2-hydroxy-3-methacryloxypropyl triethylammonium chloride, 2-hydroxy-3-methacryloxypropyl triethylammonium bromide and 2-hydroxy-3-methacryloxypropyl triethylammonium iodide.

Examples of monomers having amide groups as basic groups include dimethylacrylamide, dimethylmethacrylamide, diethylacrylamide, dimethylmethacrylamide, isopropylacrylamide and isopropylmethacrylamide.

Examples of monomers having imidazole groups, imide groups, morpholine groups or piperidyl groups as basic groups include vinylimidazole, imide acrylate, imide methacrylate, acryloylmorpholine, tetramethylpiperidyl acrylate, tetramethylpiperidyl methacrylate, pentamethylpiperidyl acrylate and pentamethylpiperidyl methacrylate.

Disclosed gel-like compositions can be produced by mixing an ionic liquid, an electromagnetic wave suppressor, a monomer or polymer and a crosslinking agent; and polymerizing and crosslinking the monomer, or crosslinking the polymer.

Commercially available products can be used as the ionic liquid. Alternatively, an ionic liquid may be synthesized using various methods including acid ester methods, complexation methods or neutralization methods.

In embodiments utilizing a phosphoric acid-based ionic liquid, a neutralization method may be utilized to synthesize it. In one such method, an amine can be added dropwise to an inorganic or organic phosphoric acid such as phosphoric acid or dibutyl phosphate. The phosphoric acid can be diluted (such as, for example, a five-fold dilution) with an organic solvent such as alcohol. The amine addition can be done under low temperature conditions, for example, at 0° C., and the mixture can then be thoroughly stirred at room temperature. The resulting solution can be distilled under reduced pressure to volatilize the solvent.

Another more specific example of a method of synthesizing a phosphoric acid-based ionic liquid adds an amine to an organic phosphoric acid ester such as trimethyl phosphate, and thoroughly stirs the mixture at 60° C. The resulting solution can then be distilled under reduced pressure to volatilize the unreacted raw material.

The obtained (either via synthesis or commercial sources) ionic liquid can be mixed with an electromagnetic wave suppressor, one or more kinds of monomers, and a crosslinking agent. The amount of electromagnetic wave suppressor is not necessarily limited, and the amount may be chosen based on desired flexibility or working shape of the gel-like composition.

Any suitable mixing ratio of the ionic liquid to the monomer can be used. In some embodiments, 100 parts by mass or less of monomer per 100 parts by mass of the ionic liquid can provide a gel-like composition with acceptable levels of flexibility.

In other embodiments, a polymer may be used instead of a monomer. Alternatively, the polymer can be combined with a monomer. A plurality of polymers or a plurality of polymers and monomers can be used. The polymer or the polymer plus monomer can be added in an amount equal to 100 parts by mass or less polymer or polymer plus monomer per 100 parts by mass of the ionic liquid.

A crosslinking agent can be added in an amount from about 0.1 parts by mass to 50 parts by mass per 100 parts by mass in total of the monomer or polymer or both. In embodiments, a crosslinking agent can be added in an amount from 0.1 parts by mass to 10 parts by mass per 100 parts by mass in total of the monomer or polymer or both.

In embodiments that utilize an acrylic acid monomer, exemplary crosslinking agents include 1,6-hexanediol diacrylate, 1,6-hexanediol dimethacrylate, epichlorohydrin (ECH)-modified 1,6-hexanediol diacrylate, ECH-modified 1,6-hexanediol dimethacrylate, 1,9-nonanediol diacrylate, 1,9-nonanediol dimethacrylate, ethylene glycol diacrylate, ethylene glycol dimethacrylate, polyethylene glycol diacrylate, polyethylene glycol dimethacrylate, propylene glycol diacrylate, propylene glycol dimethacrylate, polypropylene glycol diacrylate, polypropylene glycol dimethacrylate, ethylene oxide (EO)-modified bisphenol A diacrylate, EO-modified bisphenol A dimethacrylate, propylene oxide (PO)-modified bisphenol A diacrylate, PO-modified bisphenol A dimethacrylate, EO-modified neopentyl glycol diacrylate, EO-modified neopentyl glycol dimethacrylate, EO-modified glycerol triacrylate, ECH-modified diacrylate, ECH-modified dimethacrylate, ECH-modified ethylene glycol diacrylate, ECH-modified ethylene glycol dimethacrylate, ECH-modified propylene glycol diacrylate, ECH-modified propylene glycol dimethacrylate, ECH-modified diacrylate phthalate, ECH-modified dimethacrylate phthalate, PO-modified glycerol triacrylate, ECH-modified glycerol triacrylate, EO-modified glycerol trimethacrylate, PO-modified glycerol trimethacrylate, ECH-modified glycerol trimethacrylate, EO-modified trimethylolpropane triacrylate, PO-modified trimethylolpropane triacrylate, 1,6-hexanediol diglycidyl ether, hydrogenated bisphenol A diglycidyl ether, neopentyl glycol diglycidyl ether, glycerol polyglycidyl ether, diglycerol polyglycidyl ether, polyglycerol polyglycidyl ether, trimethylolpropane polyglycidyl ether, pentaerythritol polyglycidyl ether, sorbitol polyglycidyl ether, diglycidyl terephthalate, diglycidyl phthalate, ethylene glycol diglycidyl ether, polyethylene glycol diglycidyl ether, propylene glycol diglycidyl ether and polypropylene glycol diglycidyl ether.

In embodiments where monomers are utilized, polymerization can be accomplished using heat or radiation. In embodiments where irradiation is utilized, E-beam radiation or the like may be used. In embodiments, a solution to be polymerized that contains an electromagnetic wave suppressor is often opaque, therefore, thermal polymerization may be more practically utilized. In such embodiments, a thermal polymerization initiator can be added. In embodiments where a thermal polymerization initiator is added, it can be added in an amount from about 0.01 parts by mass to 1 part by mass per 100 parts by mass of the monomer.

Examples of thermal polymerization initiators include thermal polymerization initiators produced by Wako Pure Chemical Industries, Ltd. (Osaka, Japan), such as 2,2′-azobis[2-(2-imidazolin-2-yl)propane] dihydrochloride (VA-044), 2,2′-azobis[2-(2-imidazolin-2-yl)propane] disulfate dihydrate (VA-046B), 2,2′-azobis(2-methylpropionamidine) dihydrochloride (V-50), 2,2′-azobis[N-(2-carboxylethyl)-2-methylpropionamidine] hydrate (VA-057), 2,2′-azobis{2-[1-(2-hydroxyethyl)-2-imidazolin-2-yl]propane} dihydrochloride (VA-060), 2,2′-azobis[2-(2-imidazolin-2-yl)propane] (VA-061), 2,2′-azobis(1-imino-1-pyrrolidino-2-methylpropane) dihydrochloride (VA-067), 2,2′-azobis{2-methyl-N-[1,1-bis(hydroxymethyl)-2-hydroxyethyl]propionamide} (VA-080), 2,2′-azobis[2-methyl-N-(2-hydroxymethyl)-2-hydroxyethyl]propionamide (VA-086), 2,2′-azobis(4-methoxy-2,4-dimethylvaleronitrile) (V-70), 2,2′-azobis(2,4-dimethylvaleronitrile) (V-65), dimethyl 2,2′-azobis(2-methylpropionate) (V-601), 2,2′-azobis(2-methylbutyronitrile) (V-59), 1,1′-azobis(cyclohexane-1-carbonitrile) (V-40), 2,2′-azobis[N-(2-propenyl)-2-methylpropionamide] (VF-096), 1-[(1-cyano-1-methylethyl)azo]formamide (V-30), 2,2′-azobis(N-butyl-2-methylpropionamide) (VAm-110), and 2,2′-azobis(N-cyclohexyl-2-methylpropionamide) (VAm-111); and thermal polymerization initiators produced by NOF Corp. (Tokyo, Japan), such as diisobutyryl peroxide (PEROYL IB), cumyl peroxyneodecanoate (PERCUMYL ND), di-n-propyl peroxydicarbonate (PEROYL NPP), diisopropyl peroxydicarbonate (PEROYL IPP), di-sec-butyl peroxydicarbonate (PEROYL SBP), 1,1,3,3-tetramethylbutyl peroxydecanoate (PEROCTA ND), di(2-ethylhexyl)peroxydicarbonate (PEROYL OPP), di(4-tert-butylcyclohexyl)peroxydicarbonate (PEROYL TCP), tert-hexyl peroxyneodecanoate (PERHEXYL ND), tert-butyl peroxyneodecanoate (PERBUTYL ND), tert-butyl peroxyneoheptanoate (PERBUTYL NHP), tert-hexyl peroxypivalate (PERHEXYL PV), tert-butyl peroxypivalate (PERBUTYL PV), di(3,5,5-trimethylhexanoyl)peroxide (PEROYL 355), dilauryl peroxide (PEROYL L), 1,1,3,3-tetramethylbutyl peroxy-2-ethylhexanoate (PEROCTA 0), disuccinic acid peroxide (PEROYL SA), 2,5-dimethyl-2,5-di(2-ethylhexylperoxy)hexane (PERHEXA 250), tert-hexyl peroxy-2-ethylhexanoate (PERHEXYL 0), di(4-methylbenzoyl)peroxide (NYPER PMB), tert-butyl peroxy-2-ethylhexanoate (PERBUTYL 0), a mixture of di(2-methylbenzoyl)peroxide, benzoyl(3-methylbenzoyl)peroxide and dibenzoyl peroxide (NYPER BMT), dibenzoyl peroxide (NYPER BW), 1,1-di(tert-butylperoxy)-2-methylcyclohexane (PERHEXA MC), 1,1-di(tert-hexylperoxy)-3,3,5-trimethylcyclohexane (PERHEXA TMH), 1,1-di(tert-hexylperoxy)cyclohexane (PERHEXA HC), 1,1-di(tert-butylperoxy)cyclohexane (PERHEXA C), 2,2-di(4,4-di-(tert-butylperoxy)cyclohexyl)propane (PERTETRA A), tert-hexyl peroxy isopropyl monocarbonate (PERHEXYL I), tert-butyl peroxymaleic acid (PERBUTYL MA), tert-butyl peroxy-3,5,5-trimethylhexanoate (PERBUTYL 355), tert-butyl peroxylaurate (PERBUTYL L), tert-butyl peroxy isopropyl monocarbonate (PERBUTYL L), tert-butyl peroxy-2-ethylhexyl monocarbonate (PERBUTYL I), tert-hexyl peroxybenzoate (PERHEXYL Z), 2,5-di-methyl-2,5-di(benzoylperoxy)hexane (PERHEXA 25Z), tert-butyl peroxyacetate (PERBUTYL A), 2,2-di-(tert-butylperoxy)butane (PERHEXA 22), tert-butyl peroxybenzoate (PERBUTYL Z), n-butyl 4,4-di-(tert-butylperoxy)valerate (PERHEXA V), di(2-tert-butylperoxyisopropyl)benzene (PERBUTYL P), dicumyl peroxide (PERCUMYL D), di-tert-hexyl peroxide (PERHEXYL D), 2,5-dimethyl-2,5-di(tert-butylperoxy)hexane (PERHEXA 25B), tert-butyl cumyl peroxide (PERBUTYL C), di-tert-butyl peroxide (PERBUTYL D), p-menthane hydroperoxide (PERMENTHA H), 2,5-dimethyl-2,5-di(tert-butylperoxy)hexyne-3 (PERHEXYN 25B), diisopropylbenzene hydroperoxide (PERCUMYL P), 1,1,3,3-tetramethylbutyl hydroperoxide (PEROCTA H), cumene hydroperoxide (PERCUMYL H), tert-butyl hydroperoxide (PERBUTYL H), and 2,3-dimethyl-2,3-diphenylbutane (NOFMER BC).

Various additives may also be added to gel-like compositions. For example, gel like-compositions may be colored by adding pigments or dyes. Also, tackifiers, surface lubricating agents, leveling agents, antioxidants, corrosion inhibitors or the like may also be added if desired.

The thermal conductivities of gel-like compositions may be further enhanced by adding thermally conductive particles. Known thermally conductive particles can be utilized, such as aluminum oxide and silicon carbide for example.

Flame retardant properties may be imparted to the gel-like compositions by employing a flame-retardant ionic liquid, for example one that has a phosphoric acid-based anion. Flame-retardant properties may also be imparted by separately adding a fire-retarding material. Known fire-retarding materials can be utilized, such as aluminum hydroxide and magnesium hydroxide for example. In embodiments that add aluminum hydroxide, the particles can have average particle diameters of 0.1 to 100 μm and can be added in an amount from 10 to 50 mass %. Such gel-like compositions can satisfy the V-0 level of the UL-94 test.

The gel-like compositions can be formed into a desired shape when the monomer is polymerized. The shape thereof is not limited and may be, for example, a sheet form having a thickness of from several millimeters (mm) to tens of millimeters or a film form of several millimeters or less. In embodiments where the gel-like composition is to be disposed inside an electronic device, the composition may be formed into a shape defined by the electronic device.

In embodiments where the gel-like composition will be formed into a sheet or a film, a solution can be coated on a resin film and utilized as is. Commonly utilized resin films can be used. In embodiments, films that are flexible can be utilized. Examples of films that can be utilized include polyethylene, polypropylene, vinyl chloride, polycarbonate, thermoplastic polyurethane, cellophane, vinylidene fluoride, polyethylene terephthalate (PET), polystyrene, vinylidene chloride acryl, polyurethane, polyolefin, fluorine-based resin (e.g., PVdF, ETFE), polyimide, phenolic resin, epoxy resin, polyamide and polyphenylene ether. In embodiments, a resin film to be used can have relatively good heat resistance, such as release-treated polyethylene terephthalate (PET).

Once the solution is coated onto the film, another release-treated PET film can be laminated thereon. The laminate can then be heated at a temperature not higher than the heat-resistant temperature of the resin film to polymerize the solution. The two films can be peeled off after the polymerization to form a sheet or film of the gel-like composition. The gel-like composition positioned between two resin films may also be used as the electromagnetic wave suppressor without removing the two films. The ends of the two resin films may also be sealed to fabricate a construction of the gel-like composition that is hermetically enclosed.

Similarly, only one of the two resin films of the laminate may have a release treatment thereon. Such a laminate, after peeling off one resin film (the release treated one) can be laminated to a place where the gel-like composition is intended to be used. In embodiments that utilize an acrylic acid homopolymer or copolymer as the polymer of the gel-like composition, the gel-like composition itself can have self-adhesive properties and can be used by directly laminating it to a desired location.

Disclosed gel-like compositions can have electromagnetic wave suppressing properties, thermally conductive properties, impact absorptivity, vibration absorptivity, flame retardance or any combination thereof. The properties imparted to the gel-like composition can be chosen at least in part based on the desired application for the gel-like composition.

An exemplary application of a disclosed gel-like composition that has electromagnetic wave suppressing properties and thermal conductivity properties is to coat the gel-like composition on a substrate that has a semiconductor circuit or other heat generating device mounted thereon. Other exemplary applications include drive circuit substrates of liquid crystal televisions, plasma televisions or the like; high-performance IC circuit substrates used for CPUs, graphic motion or the like in personal computers or video-game consoles; or on power transistors or power source components.

Embodiments of gel-like compositions that are flexible and have impact absorptivity and vibration absorptivity (as well as electromagnetic wave suppressing ability and thermal conductivity properties) can advantageously be used around motors to suppress vibration and affect noise control. Disclosed gel-like compositions can also be used as packaging members of precision machinery or can be laminated to a position on the inner or outer wall of packaging for electric or electronic products. Such an application could utilize the thermally conductive, electromagnetic wave suppressing, impact absorbing, and antistatic properties of the gel-like composition.

Gel-like compositions utilized around an engine or as a building member of automobiles could provide advantages as an impact absorber as well as be flame retardant. Such an application could also benefit from the nonvolatile nature of the gel-like composition as it would have stable properties over a wide temperature range.

### EXAMPLES

The present disclosure is described below by referring to Examples, but the scope of the present disclosure is not limited to those described in the Examples.

### Preparation of Materials

### Synthesis of (EtOH)₃MeN-Me₂PO₄

52 parts by mass of trimethyl phosphate (Me₃PO₄, Daihachi Chemical Industry Co., Ltd., Osaka, Japan) and 50 parts by mass of triethanolamine ((EtOH)₃N, Japan Alcohol Trading Co., Ltd., Tokyo, Japan) were added to a 500 mL-volume Kjeldahl flask and stirred under heating for 24 hours at 60° C. in the air using an oil bath. The mixture was distilled under reduced pressure at 120° C. and 100 Pa for 2 hours to obtain (EtOH)₃MeN-Me₂PO₄, which was a pale yellow viscous liquid at room temperature.

### Synthesis of (EtOH)₂Me₂N-Me₂PO₄

50 parts by mass of trimethyl phosphate (Me₃PO₄, Daihachi Chemical Industry Co., Ltd., Osaka, Japan) and 43 parts by mass of N-methyldiethanolamine ((EtOH)₂MeN, Nippon Nyukazai Co., Ltd., Tokyo, Japan) were added to a 500 mL-volume Kjeldahl flask equipped with a reflux condenser and a rotor, and stirred under heating for 24 hours at 60° C. in the air using an oil bath. The mixture was distilled under reduced pressure at 120° C. and 100 Pa for 2 hours to obtain (EtOH)₂Me₂N-Me₂PO₄, which was a pale yellow viscous liquid at room temperature.

### Evaluation of Samples

### Evaluation of Electromagnetic Wave Suppressing Ability

The electromagnetic wave suppressing ability was evaluated using a 50 mm×50 mm square of the respective sample. The sample was laminated onto a 28 mm-long (characteristic impedance: 50 ohm) microstrip line formed on the front surface of a substrate having an electrically conductive layer on the back surface. A network analyzer terminal was connected to both ends of the microstrip line; an input signal (S11) was supplied from one terminal; an output signal (S21) was measured from another terminal; and the power loss was calculated in accordance with formula (I).

Power Loss (%)=(1−|S21|²−|S11|²)×100 (Formula 1)

The calculated power loss value allows the electromagnetic wave suppressing ability of the samples to be evaluated and compared.

### Evaluation of Thermally Conductivity

The thermal conductivity was evaluated using a 40 mm×100 mm portion of the respective sample. The measurement was performed in accordance with JISR2616 using Kemtherm measurement apparatus (QTM-D3) and probe (PD-13) (Kyoto Electronics Manufacturing Co., Ltd., Kyoto, Japan). The method utilizes a substrate with a coefficient of thermal conductivity that is low in comparison to the sample. The substrate includes a linear heat source disposed on the surface and a temperature sensor in the center. The sample was then laminated to the surface of the substrate. The temperature rise in a given time is measured. The same procedure is carried out on a material having a known coefficient of thermal conductivity. The temperature rise of the sample is then utilized to calculate the thermal conductivity of the sample.

### Measurement of the Hardness of a Sample

A number of sheets of the sample to be tested were stacked to prepare a structure about 6 mm thick. The Asker C hardness of the structure was then measured using an Asker C hardness meter (a durometer or spring-type hardness tester specified in SRIS 0101).

### Flame Retardance Test of Samples

The flame retardance of a sample was evaluated using the flame retardance test method specified by The Underwriters Laboratories Inc. (UL), test No. UL-94.

### Examples and Comparative Examples

### Example 1

100 parts by mass of (EtOH)₃MeN-Me₂PO₄ (prepared as above), 43 parts by mass of 2-hydroxyethylacrylamide monomer (HEAA, Kohjin Co., Ltd., Tokyo, Japan), 0.69 parts by mass of 1,6-hexanediol diacrylate (HDDA, Nippon Shokubai Co., Ltd., Osaka, Japan), 0.17 parts by mass of 2,2′-azobis(2,4-dimethylvaleronitrile) (V-65, Wako Pure Chemical Industries, Ltd., Osaka, Japan), and 95 parts by mass of sendust as the electromagnetic wave suppressor (Fe—Al—Si, PST-4, average particle diameter D50: 50 μm, aspect ratio: 15, Sanyo Special Steel Co., Ltd., Hyogo, Japan) were mixed and the system was vacuum-deaerated at 100 Pa for 15 minutes.

The resulting solution was knife coated onto a 25 μm-thick release-treated polyethylene terephthalate film (PET, SP-PET-01-25-Bu, Tohcello Co., Ltd. Tokyo, Japan, referred to hereafter as “PET film”) to a thickness of 1.3 mm. Another PET film was then laminated onto the coated surface. This laminate was heated at 100° C. for 10 minutes to completely react and cure the solution to produce a sheet-shaped gel-like composition.

### Example 2

A gel-like composition was produced as described in Example 1 except that 572 parts by mass of Ni—Zn-based ferrite particles (BSN-828, average particle diameter D50: 5.1 μm, Toda Kogyo Corp., Hiroshima, Japan) was used as the electromagnetic wave suppressor.

### Example 3

A gel-like composition was produced as described in Example 1 except that 572 parts by mass of Mn—Zn-based ferrite particles (BSF-547, average particle diameter D50: 3.2 μm, produced by Toda Kogyo Corp., Hiroshima, Japan) was used as the electromagnetic wave suppressor

### Example 4

100 Parts by mass of (EtOH)₃MeN-Me₂PO₄ (prepared as above), 25 parts by mass of 2-hydroxyethyl methacrylate monomer (HEMA, Wako Pure Chemical Industries, Ltd., Osaka, Japan), 0.75 parts by mass of polyethylene glycol diacrylate (NK Ester A-600, Shin-Nakamura Chemical Co., Ltd., Wakayama, Japan), 0.13 parts by mass of 2,2′-azobis(2,4-dimethylvaleronitrile) (V-65, Wako Pure Chemical Industries, Ltd., Osaka, Japan), and 500 parts by mass of spherical sendust (PSP, average particle diameter D50: 30 μm, Sanyo Special Steel Co., Ltd., Hyogo, Japan) as an electromagnetic wave suppressor, were mixed and the system was vacuum-deaerated at 100 Pa for 15 minutes.

The resulting solution was knife coated onto a PET film to a thickness of 1.3 mm. Another PET film was then laminated onto the coated surface. This laminate was heated at 100° C. for 10 minutes to completely react and cure the solution to produce a sheet-shaped gel-like composition.

### Example 5

A gel-like composition was produced as described in Example 4 except that 55 parts by mass of flat sendust (EMS, average particle diameter D50: 61 μm, aspect ratio: 45.1, produced by JEMCO Inc. (Tokyo, Japan) was utilized as the electromagnetic wave suppressor.

### Example 6

A gel-like composition was produced as described in Example 1 except that 102 parts by mass of aluminum hydroxide (H-34, Showa Denko K.K., Tokyo, Japan) was added as a flame retardant material. A gel-like composition having a thickness of 1.6 mm was produced as described in Example 1.

### Example 7

100 Parts by mass of (EtOH)₂Me₂N-Me₂PO₄ (prepared as described above), 43 parts by mass of 2-hydroxyethylacrylamide (HEAA, Kohjin Co., Ltd., Tokyo, Japan), 0.69 parts by mass of 1,6-hexanediol diacrylate (HDDA, Nippon Shokubai Co., Ltd., Osaka, Japan), 0.17 parts by mass of 2,2′-azobis(2,4-dimethylvaleronitrile) (V-65, Wako Pure Chemical Industries, Ltd., Osaka, Japan), and 95 parts by mass of flat sendust (Fe—Al—Si) (PST-4, Sanyo Special Steel Co., Ltd., Hyogo, Japan) were mixed and the system was vacuum-deaerated at 100 Pa for 15 minutes. The resulting solution was knife coated onto two PET films to a thickness of 1.3 mm. Two other PET films were then independently laminated onto the coated surfaces. Each laminate was heated at 100° C. for 10 minutes to completely react and cure the solution to produce gel-like compositions.

### Comparative Examples 1 to 3

Gel-like compositions were produced as described in Example 3 except that different amounts of the Mn—Zn-based ferrite particles (BSF-547, average particle diameter D50: 3.2 μm, Toda Kogyo Corp., Hiroshima, Japan) were utilized: 36 parts by mass per 100 parts by mass of (EtOH)₃MeN-Me₂PO₄ in Comparative Example 1; 96 parts by mass per 100 parts by mass of (EtOH)₃MeN-Me₂PO₄ in Comparative Example 2; and 216 parts by mass per 100 parts by mass of (EtOH)₃MeN-Me₂PO₄ in Comparative Example 3.

### Comparative Example 4

A polymer sheet without an electromagnetic wave suppressor was produced under the following conditions.

100 Parts by mass of (EtOH)₃MeN-Me₂PO₄ (prepared as discussed above), 43 parts by mass of 2-hydroxyethylacrylamide (HEAA, Kohjin Co., Ltd., Tokyo, Japan), 0.17 parts by mass of 1,6-hexanediol diacrylate (HDDA, Nippon Shokubai Co., Ltd., Osaka, Japan), and 0.17 parts by mass of 2-hydroxy-2-methyl-1-phenyl-propan-1-one (Darcur™ 1173, Ciba Specialty Chemicals Corp.) as a photopolymerization initiator were mixed and the system was vacuum-deaerated at 100 Pa for 15 minutes.

The resulting solution was knife coated onto a PET film to a thickness of 1.3 mm. Another PET film was then laminated onto the coated surface. This laminate was then ultraviolet (UV) irradiated at 2,500 mJ/cm² to completely polymerize the solution.

### Comparative Example 5

A polymer sheet without an ionic liquid was produced under the following conditions.

100 parts by mass of a 2-ethylhexyl acrylate monomer (2-EHA, Nippon Shokubai Co., Ltd., Osaka, Japan) and 0.01 parts by mass of 2-hydroxy-2-methyl-1-phenyl-propan-1-one (Darcur™ 1173, Ciba Specialty Chemicals Corp.) were mixed and the system was replaced with nitrogen gas for 10 minutes. The resulting solution was UV irradiated at 3 mJ/cm² to prepare a partial polymer having a viscosity of about 1,000 cp.

The partial polymer was mixed with 0.4 parts by mass of 1,6-hexanediol diacrylate (HDDA, Nippon Shokubai Co., Ltd., Osaka, Japan), 0.4 parts by mass of 2,2′-azobis(2,4-dimethylvaleronitrile) (V-65, Wako Pure Chemical Industries, Ltd., Osaka, Japan), 0.03 parts by mass of a dispersion aid (DisperBYK-111, BYK Chemie GmbH (Germany)) and 67 parts by mass of flat sendust (Fe—Al—Si) (PST-4, Sanyo Special Steel Co., Ltd., Hyogo, Japan) as an electromagnetic wave suppressor. The system was vacuum-deaerated at 100 Pa for 15 minutes.

The resulting solution was knife coated onto a PET film to a thickness of 1.3 mm. Another PET film was then laminated on the coated surface. This laminate was heated at 100° C. for 10 minutes to cure the solution to produce a polymer sheet.

### Comparative Example 6

A polymer sheet without an ionic liquid was as described in Comparative Example 5 except that 404 parts by mass of Mn—Zn-based ferrite (BSF-547, average particle diameter D50: 3.2 μm, produced by Toda Kogyo Corp., Hiroshima, Japan) was added as the electromagnetic wave suppressor.

Table 1 shows the components and amounts thereof in Examples 1 to 7 and Comparative Examples 1 to 6.

TABLE 1

| | | Electromagnetic Wave | | | |
|---|---|---|---|---|---|
| | | Suppressor | | | |
| | | (Parts by mass ) | Monomer | HDDA | V-65 |
| Example | Ionic Liquid | (Volume Ratio-%) | (Parts by | (Parts by | (Parts by |
| Number | (parts by mass) | (Mass Ratio-%) | mass) | Mass) | Mass) |
| 1 | (EtOH)₃MeN—Me₂PO₄ | PST-4, flat sendust | HEAA | 0.69 | 0.17 |
| | (100) | (95) (10%) (40%) | (43) | | |
| 2 | (EtOH)₃MeN—Me₂PO₄ | BSN-828, Ni—Zn-based ferrite | HEAA | 0.69 | 0.17 |
| | (100) | (572) (51%) (80%) | (43) | | |
| 3 | (EtOH)₃MeN—Me₂PO₄ | BSF-547, Mn—Zn-based ferrite | HEAA | 0.69 | 0.17 |
| | (100) | (572) (51%) (80%) | (43) | | |
| 4 | (EtOH)₃MeN—Me₂PO₄ | PSP, spherical sendust | HEMA | 0.75 | 0.13 |
| | (100) | (500) (42%) (80%) | (25) | | |
| 5 | (EtOH)₃MeN—Me₂PO₄ | EMS, flat sendust | HEMA | 0.75 | 0.13 |
| | (100) | (55) (7%) (30%) | (25) | | |
| 6*¹⁾ | (EtOH)₃MeN—Me₂PO₄ | PST-4, flat sendust | HEAA | 0.69 | 0.17 |
| | (100) | (95) (8%) (28%) | (43) | | |
| 7 | (EtOH)₂Me₂N—Me₂PO₄ | PST-4, flat sendust | HDDA | 0.69 | 0.17 |
| | (100) | (95) (10%) (40%) | (43) | | |
| C1 | (EtOH)₃MeN—Me₂PO₄ | BSF-547, Mn—Zn-based ferrite | HEAA | 0.69 | 0.17 |
| | (100) | (36) (6%) (20%) | (43) | | |
| C 2 | (EtOH)₃MeN—Me₂PO₄ | BSF-547, Mn—Zn-based ferrite | HEAA | 0.69 | 0.17 |
| | (100) | (96) (15%) (40%) | (43) | | |
| C 3 | (EtOH)₃MeN—Me₂PO₄ | BSF-547, Mn—Zn-based ferrite | HEAA | 0.69 | 0.17 |
| | (100) | (216) (28%) (60%) | (43) | | |
| C 4 | (EtOH)₃MeN—Me₂PO₄ | Not Present | HEAA | 0.17 | 0.17*²⁾ |
| | (100) | (0) (0%) (0%) | (43) | | |
| C 5 | Not Present | PST-4, flat sendust | 2-EHA | 0.4 | 0.4 |
| | (0) | (67) (9%) (40%) | (100) | | |
| C 6 | Not Present | BSF-547, Mn—Zn-based ferrite | 2-EHA | 1.6 | 0.4 |
| | (0) | (404) (48%) (80%) | (100) | | |

*¹⁾Aluminum hydroxide as a flame retardant was added.
²⁾A photopolymerization agent was used

### Results

Table 2 shows the results of the various evaluative measurements discussed above.

TABLE 2

| | | | Power Loss | Thermal | |
|---|---|---|---|---|---|
| Example | Thickness | Density | at 1 GHz | Conductivity | Hardness |
| Number | (mm) | (g/cm³) | (%) | (W/m/k) | (Asker C) |
| 1 | 1.3 | 1.8 | 16 | 0.9 | 25 |
| 2 | 1.3 | 3.1 | 8 | 1.2 | 21 |
| 3 | 1.3 | 3.1 | 18 | 1.3 | 39 |
| 4 | 1.3 | 3.7 | 12 | 1.2 | 30 |
| 5 | 1.3 | 1.7 | 14 | 0.8 | 22 |
| 6 | 1.6 | 1.9 | 13 | 1.3 | 46 |
| 7 | 1.3 | 1.8 | 15 | 0.9 | 21 |
| C 1 | 1.1 | 1.5 | 4 | 0.2 | 4 |
| C 2 | 1.1 | 1.7 | 7 | 0.4 | 6 |
| C 3 | 1.2 | 2.2 | 10 | 0.7 | 15 |
| C 4 | 1.3 | 1.5 | 4 | 0.2 | 0 |
| C 5 | 1.3 | 1.5 | 5 | 0.6 | 0 |
| C 6 | 1.2 | 2.8 | 6 | 0.8 | 63 |

By comparing Comparative Examples 1 to 3 and Example 3, it can be seen that the power loss at 1 GHz (which indicates the electromagnetic wave suppressing ability) increases as the ferrite content increases. The thermal conductivity also increases along with the increasing ferrite content. Specifically, when the electromagnetic wave suppressor was increased from 60 mass % to 80 mass %, the value of the thermal conductivity was markedly elevated.

From a comparison of Comparative Examples 4 and 5 and Example 1, it can be seen that the gel-like composition not containing flat sendust (Comparative Example 4) and the gel-like composition not containing an ionic liquid (Comparative Example 5) each exhibited a power loss value of 4% and 5%, respectively. However, Example 1 (the gel-like composition containing an ionic liquid and flat sendust) showed a significantly higher power loss value of 16%.

Only Example 6 was evaluated for flame retardance, and as seen there, the V-0 level can be achieved.

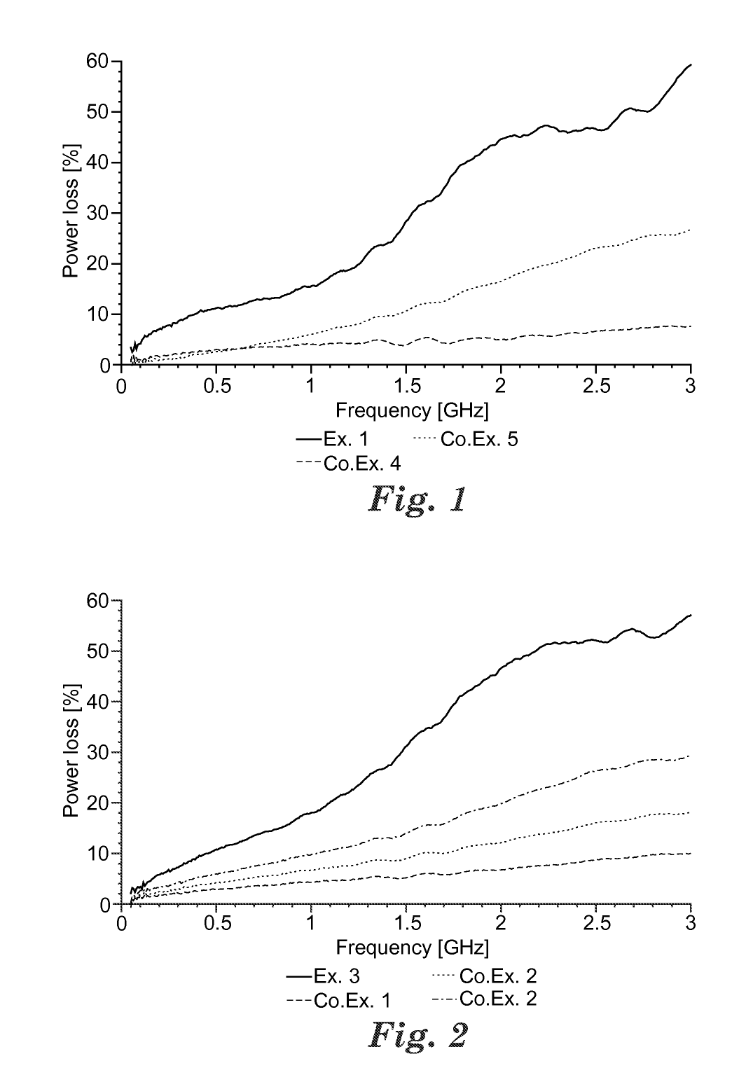

FIG. 1 illustrates the electromagnetic wave suppressing effect from 0.1 GHz to 3 GHz for Example 1 and Comparative Examples 4 and 5. A frequency and a power loss (%) are taken on the abscissa and the ordinate, respectively. As illustrated in FIG. 1, in comparison with the ionic liquid gel not containing an electromagnetic wave suppressor (Comparative Example 4) and the polymer containing flat sendust without using an ionic liquid (Comparative Example 5), the gel-like composition containing flat sendust in an ionic liquid gel (Example 3) exhibits high electromagnetic absorptivity, that is, high electromagnetic wave suppressing effect.

FIG. 2 illustrates the electromagnetic wave suppressing effect from 0.1 GHz to 3 GHz for Example 3 and Comparative Examples 1 to 3. The frequency and power loss (%) are taken on the abscissa and the ordinate, respectively. As illustrated in FIG. 2, the electromagnetic absorptivity (power loss value) increases as the content of Mn—Zn ferrite in the gel-like composition increases from 20 mass % (Comparative Example 1) to 40 mass % (Comparative Example 2) to 60 mass % (Comparative Example 3), and shows an even more significant increase from 60 mass % (Comparative Example 3) to 80 mass % (Example 3).

1. A gel-like composition comprising:
a gel, wherein the gel comprises (a) a polymer and (b) an ionic liquid contained in a network of the polymer, wherein the gel contains a lower mass of polymer than ionic liquid; and
an electromagnetic wave suppressor,
wherein the electromagnetic wave suppressor is dispersed in the gel and wherein the thermal conductivity of the gel-like composition is at least 0.8 W/mK.

2. The gel-like composition according to claim 1, wherein the electromagnetic wave suppressor is an electric conductor, a dielectric material, a magnetic material, or a combination thereof.

3. The gel-like composition according to claim 2, wherein the electromagnetic wave suppressor comprises a soft magnetic material.

4. The gel-like composition according to claim 3, wherein the soft magnetic material is a ferrite material.

5. The gel-like composition according to claim 4, wherein the ferrite is present in the gel-like composition in an amount of 50 vol % or more.

6. The gel-like composition according to claim 4, wherein the ferrite is present in the gel-like composition in an amount of 80 mass % or more.

7. The gel-like composition according to claim 3, wherein the soft magnetic material is sendust.

8. The gel-like composition according to claim 7, wherein the sendust is present in the gel-like composition in an amount of 7 vol % or more.

9. The gel-like composition according to claim 7, wherein the sendust is present in the gel-like composition in an amount of 25 mass % or more.

10. The gel-like composition according to claim 1, wherein the ionic liquid is a non-halogenated ionic liquid.

11. The gel-like composition according to claim 1, wherein the ionic liquid has at least one anion selected from the group consisting of a phosphate anion and a phosphoric acid ester anion.

12. The gel-like composition according to claim 11, wherein the ionic liquid contains a quaternary ammonium cation and a phosphoric acid diester anion.

13. The gel-like composition according to claim 1, wherein the polymer contains a carboxyl group or a hydroxyl group in the constituent unit.

14. The gel-like composition according to claim 1, wherein said polymer is an acrylic polymer.

15. The gel-like composition according to claim 1, wherein the gel-like composition has a sheet form with a thickness of 0.3 to 5.0 mm.
